(19) United States
(12) Patent Application Publication
(10) Pub. No.: US 2023/0105046 A1
(43) Pub. Date: Apr. 6, 2023

(54) SYSTEMS AND METHODS FOR AUTOMATED PERSONALIZED INCENTIVES

(71) Applicant: BetFully, Inc., Carlsbad, CA (US)

(72) Inventors: Erik Groset, Carlsbad, CA (US); Jason Pang, San Marcos, CA (US); Peter Groset, Waterford, WI (US); Elioth Almada Sanabia, Chula Vista, CA (US); Christopher Ramos, San Diego, CA (US)

(73) Assignee: BetFully, Inc., Carlsbad, CA (US)

(21) Appl. No.: 17/956,589

(22) Filed: Sep. 29, 2022

Related U.S. Application Data
(60) Provisional application No. 63/252,088, filed on Oct. 4, 2021.

(51) Int. Cl. G06Q 30/02; G06Q 50/34; G07F 17/32

(52) U.S. Cl. CPC G06Q 30/0229; G06Q 50/34; G06Q 30/0227; G07F 17/3255; G07F 17/3237; G07F 17/323

(57) ABSTRACT

Systems and methods for automated personalized incentives are provided. A Universal Rewards Program (URP) automatically collects consumer data regarding spending and wagering behaviors, a provides personalized incentives such as cash back, discounts, deals, bonuses, gifts, retention incentives, referral bonuses, and other personalized incentives. The URP tailors the incentive based upon transaction data collected on the consumer. The URP can also monitor and provide an alert when spending and wagering behaviors can result in negative consequences.

### CROSS-REFERENCE TO RELATED APPLICATIONS

This application claims priority to provisional patent application Ser. No. 63/252,088, filed Oct. 4, 2021, the content of which is incorporated by reference herein in entirety.

### TECHNICAL FIELD

The disclosed subject matter generally relates to management of electronically distributed incentives and, more particularly, to systems, methods and products for providing improved automated personalized incentives in a dynamic and efficient digital communications network.

### BACKGROUND

Loyalty programs (also known as rewards or incentive programs) may be managed and distributed in a computer-implemented environment to reward consumers engaged in various activities and transactions. Consumers who sign up for loyalty programs generally receive a unique identification (e.g., a reward card, a telephone number, a barcode, a QR code, etc.) that they can present at the time of a transaction. Depending on the nature of the transaction or the accumulated rewards in the loyalty account, some discounts or rewards are made available to the consumer. Reward points are often added to the consumer's account for future redemption.

In addition to incentivizing consumers, reward programs also provide certain benefits to businesses that use such programs (e.g., attract new consumers, improve sales, collect consumer data, etc.). Some disadvantages associated with the traditional loyalty programs include the need for the consumer carrying multiple reward cards, which may be burdensome. Also, consumers may forget to scan their cards at checkout, thus losing reward points or discounts. Further, often reward points are specific to a particular program and cannot be pooled across different programs.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, a Universal Rewards Program (URP) is provided that can overcome challenges of traditional loyalty programs by automatically gathering the transactional data on consumer spending and generating personalized incentives for the consumer. The URP can factor both retail spending, as well as wagering, in creating an incentive unique to the given consumer. The URP can incentivize consumers to visit certain establishments in order to partake in a discount or promotion, as well as provide an alert for problematic spending behaviors.

In some embodiments, user activity is monitored including events associated with one or more transactions over at least one of a financial platform and a wagering platform. One or more promotions are provided to the user, in response to analyzing user activity and the events. The one or more promotions may include a first amount of reward points added to a loyalty account associated with the user based on a first value associated with a first transaction and a second amount of reward points added to the loyalty account associated with the user based on a second value associated with a second transaction, such that the first amount of reward points is higher than the second amount of reward points, when the first value is greater than the second value.

Depending on implementation, the first reward points and the second reward points are accumulated in the loyalty account associated with a universal rewards program (URP) that enables the user to use the accumulated reward points across multiple rewards programs associated with the URP. The user activity may include at least one or more of a merchandize purchase, a service order, a wagering bet, a credit card transaction, and a bank transaction. The first amount of reward points are locked for a first period of time and the second amount of reward points are locked for a second amount of time different than the first amount of time. The locking of reward points prevents the user from using the reward points.

In certain aspects, the first reward points are transferable from a first user to a second user and the second reward points are non-transferable. The URP may be configured to identify problematic wagering based analyzing data associated with the one or more transactions or to identify high-value consumers based analyzing data associated with the one or more transactions. The data can include at least one of win or loss amounts in one or more wagering accounts associated with the user, date and time of a transaction, amount of wagers, and location of the transaction.

Implementations of the current subject matter may include, without limitation, systems and methods consistent with the above methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines may exchange data, commands or other instructions via one or more connections, including but not limited to a connection over a network.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1A illustrates an example operating environment in accordance with one or more embodiments, wherein electronic incentive management systems and award programs are implemented over a computer-implemented platform.

FIG. 1B is an example flow diagram of a method of implementing a Universal Rewards Program (URP), in accordance with one embodiment.

FIG. 2 is an example of the integration of banking and financial systems for a URP, in accordance with one embodiment.

FIG. 3 is a block diagram of an example computing system that may be utilized to integrate a gaming operator for a URP.

FIG. 4 illustrates a block diagram of an example system architecture for a URP, in accordance with one or more embodiments.

FIG. 5 is a block diagram of an example computing system that may be utilized to perform one or more computing operations or processes as consistent with one or more disclosed features.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

Products, systems and methods for delivery of automated personalized incentives are provided. A Universal Rewards Program (URP) is implemented over a computing platform to automatically collect consumer data regarding spending and wagering behavior and to dynamically provide incentives such as cash back, discounts, deals, bonuses, gifts, retention incentives, referral bonuses, and other personalized incentives. The URP tailors the incentive based upon transaction data collected on the consumer or the user. The URP can also monitor and provide an alert when spending and wagering behaviors can result in negative consequences.

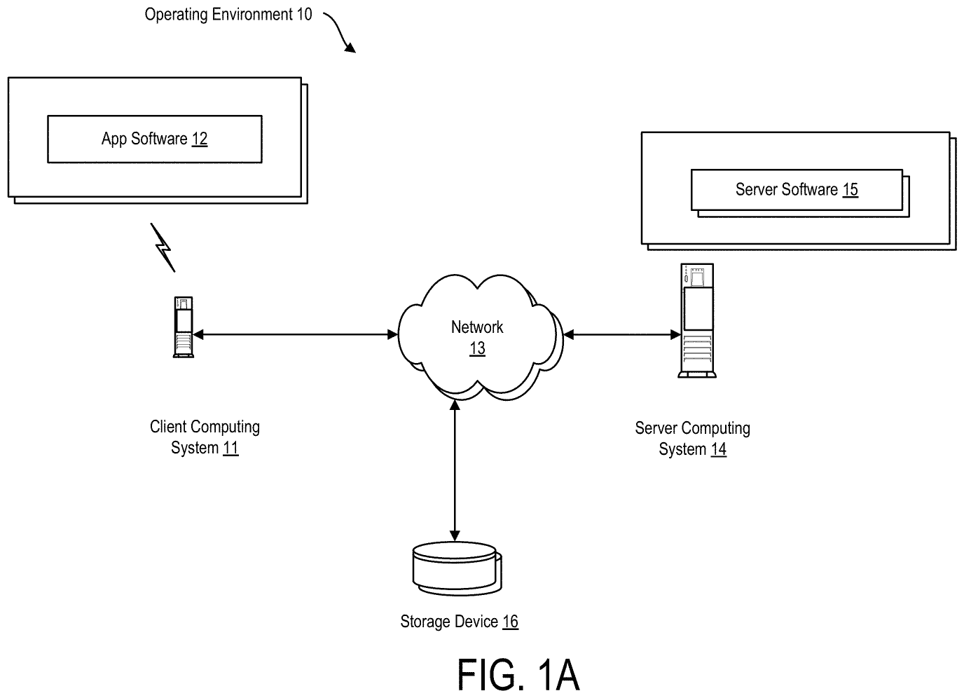

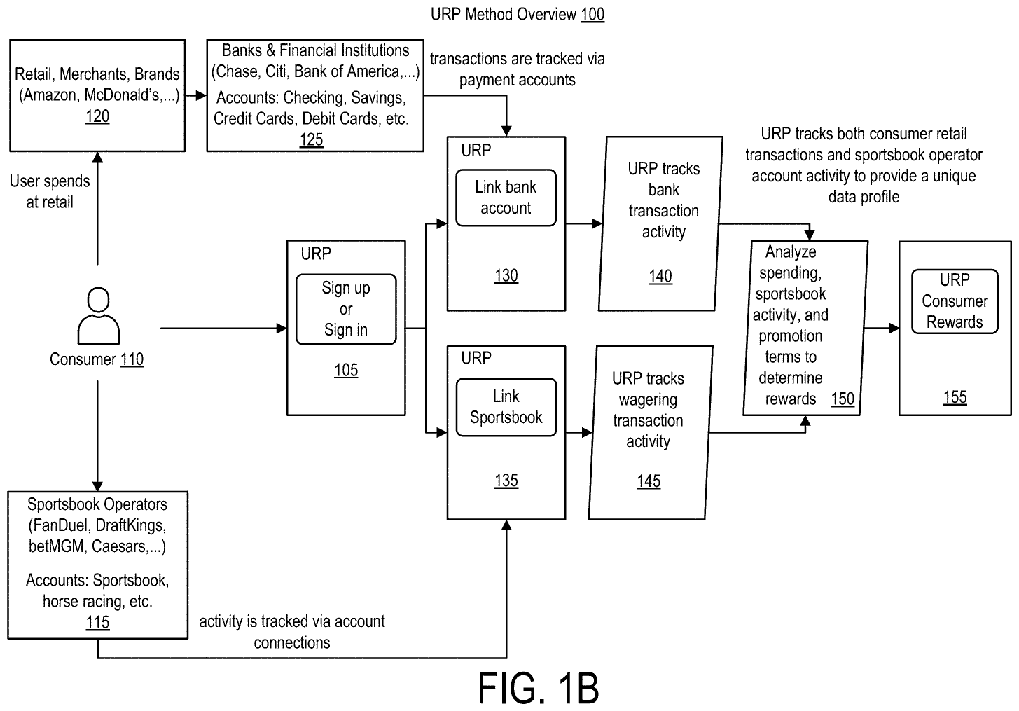

Referring to FIG. 1A, an example operating environment 10 is illustrated in which a client computing system 11 is used by a consumer or a user to interact with app software 12 being executed on client computing system 11 at the time of a transaction. The client computing system 11 may be a general purpose computer, a handheld mobile device (e.g., a smart phone), a tablet (e.g., an Apple iPad®), or other communication capable computing device. App software 12 may be a web browser, a dedicated app or other type of software application running either fully or partially on client computing system 11.

Client computing system 11, at the time of the transaction, may communicate over a network 13 to access data stored on storage device 16 or to access services provided by a server computing system 14 about the user's profile. Depending on implementation, storage device 16 may be local to, remote to, or embedded in one or more of client or server computing systems. A URP server system may be configured on server computing system 14 to service one or more requests submitted by client computing system 11 or app software 12 (e.g., client systems) via network 13. Network 13 may be implemented over a local or wide area network (e.g., the Internet).

Server computing system 14 may be implemented over a centralized or distributed (e.g., cloud-based) computing environment as dedicated resources or may be configured as virtual machines that define shared processing or storage resources. Execution, implementation or instantiation of server software 15, or the related features and components (e.g., software objects), over server computing system 14 may also define a special purpose machine that provides remotely situated client systems, such as client computing system 11 or app software 12, with access to a variety of URP data and services, for example.

In accordance with one or more implementations, the provided services by the special purpose URP server or app software 12 may include providing a user that is using client computing system 11 or app software 12 with access to URP services implemented over the operating environment 10. Among other things and without limitations, the URP services may automatically collect data about consumer spending and wagering behavior. In certain aspects, the URP services is configured to dynamically provide personalized incentives to the user based on the collected data as provided in further detail below.

Referring to FIG. 1B, an overview of example processes and methods for instrumenting and supporting a URP is provided. As shown in the URP method overview 100, a consumer 110 signs-up at step 105 if they are a first time user. Alternatively, consumer 110 may sign-in at step 105, if a URP account has previously been created. Consumer 110 can use client computing system 11, which may include, for example, a mobile device, personal computer, or terminal that runs app software 12 (e.g., an app) to enter their personal details at step 105. A first time user would select a user name and password, as well as enter personal information such as their legal name, address, age, and gender, to create a URP account in the URP system.

In some embodiments, consumer 110 may spend money shopping at step 120. Consumer 110 spending may be with online merchants, such as Amazon, or may be at brick and mortar restaurants, such as McDonalds. While a portion of the consumers may use cash for their spending, many consumers 110 may use their debit or credit cards. Debit cards may be linked to a checking account, and in some cases, transfers from a savings account may be used to purchase goods or services. At step 125, records from consumer 110 spending are stored in storage device 16, which may include the databases of banks and other financial institutions such as credit card companies.

At step 115, consumer 110 may also place one or more bets with online betting sportsbook operators, or other online wagering operators, such as for example FanDuel, DraftKings, betMGM, Caesars, etc. Alternatively, consumer 110 may place bets with brick and mortar establishments such as a casino or a horse racing track. Activity for consumer 110 wagering is tracked using respective wagering accounts (e.g. players club, rewards club, loyalty programs, etc.) with a sportsbook operator or other wagering operator, for example.

At step 135, consumer 110 may link a wagering account to a URP account associated with the consumer. AT step 130, consumer 110 may link a banking and financial institution account to the URP account. Linking accounts includes granting the URP account access to the data of the wagering account 135 and the banking and financial institution account 130. This may be accomplished by entering the respective credentials (e.g. user name and password) in the URP account for the wagering account 135 and the banking and financial institution account 130, or by entering a unique hyperlink, code, or application-programming interface (API) key connection.

At step 140, the URP tracks the bank transaction activity of consumer 110. At step 145, the URP tracks the wagering transaction activity of consumer 110. The transaction activity data may be transmitted over one or more networks 13 in an encrypted transmission. The transaction activity data may be stored in one or more URP databases 16 in an encrypted format. The URP may query the wagering account 135 and the banking and financial institution account 130 for the transaction activity data. In some embodiments, a third party financial services provider (e.g., Plaid) may query the wagering account 135 and the banking and financial institution account 130 and the transaction data may be pushed or pulled into to the URP databases.

At step 150, the URP analyzes spending and wagering activities of consumer 110. The analysis can filter transaction activity to remove data that is unrelated to consumer 110 spending at merchants and/or wagering at sportsbook operators and/or other wagering operators. The URP can build a consumer reward profile that predicts future consumer behavior based on historical transaction activity. For example, the historical transaction activity may be a 2-year lookback of consumer behavior. The URP analysis in step 150 can also look for gaps in transactional activity and trigger a personalized incentive to prevent an extended period of dormancy. The URP analysis can also factor in additional data like upcoming events (e.g., holidays, sporting events, anniversaries, etc.) in determining the personalized incentive. Other forms of additional data may be received from a mobile device including date, time, and geolocation to determine the personalized incentive.

At step 155, the URP provides consumer 110 with a personalized incentive. For example, the personalized incentive may be cash back, discounts, deals, bonuses, gifts, retention incentives, rebates, coupons, promo codes, referral bonuses, and other personalized incentives. The personalized incentive may be delivered via the URP app on the mobile device, via email, via mail, or directly to the wagering account 135 and the banking and financial institution account 130. The personalized incentive may be locked until a future date or expire within a given time period. The personalized incentive may only be valid for a particular date, time, and/or location. The personalized incentive may or may not be transferrable, or stackable with other promotions.

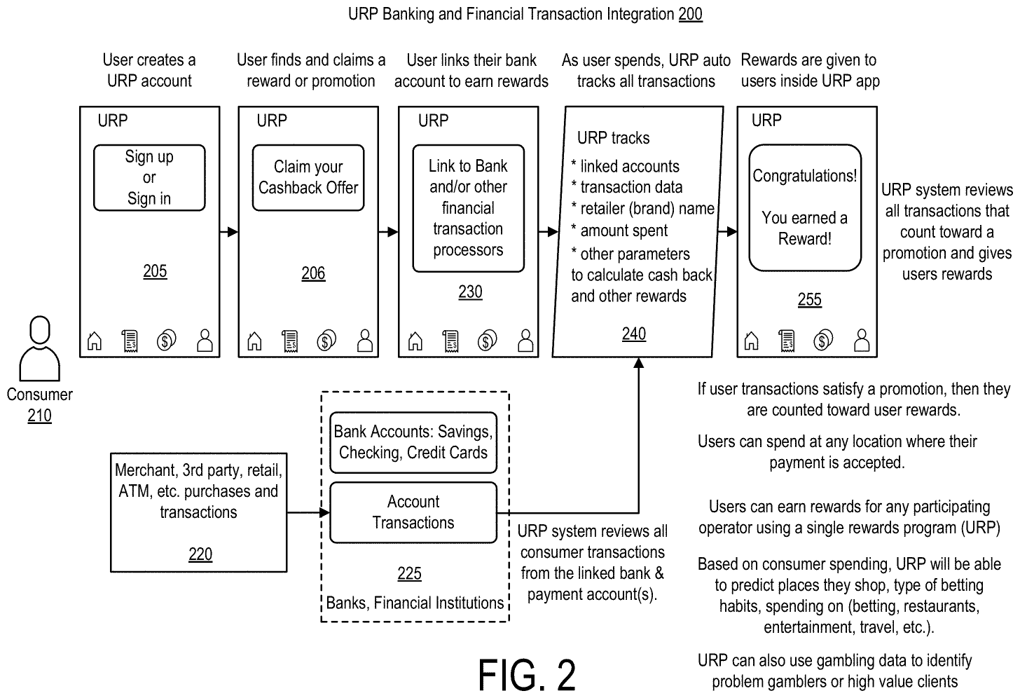

Referring to FIG. 2, an example embodiment of an integration of banking and financial systems for a URP are provided. In the URP banking and financial transaction integration 200, a consumer 210 signs-up at step 205, when a first time user, or consumer 210 signs-in at step 205 if a URP account has previously been created. Consumer 210 can use, for example, a mobile device, personal computer, or terminal that runs an application or webpage to enter their personal details in step 205. A first time user would select a user name and password, as well as enter personal information such as their legal name, address, age, and gender, to create a URP account in the URP system.

At step 206, consumer 210 may search or browse the URP application or webpage to select and claim a reward or promotional offer. In some instances, the reward or promotion may be a cashback offer. The reward or promotional offer may be redeemable at a single establishment. Alternatively, the reward or promotional offer may be redeemable at more than one establishment (e.g. retail, restaurant, or wagering operators). The reward or promotional offer may be a onetime offer for consumer 220 signing up for a URP account in step 205.

At the step 220, consumer 210 spends money shopping, or may withdraw cash from an ATM at a known location or an ATM geolocated using GPS data provided by a mobile device of consumer 210. Consumer 120 spending may be with online merchants, such as Amazon, or may be at brick and mortar restaurants, such as McDonalds. At step 225, the records from consumer 210 spending are stored in the databases of banks and other financial institutions such as credit card companies. Debit cards may be linked to a checking account, and in some cases, transfers from a savings account may be used by consumer 210 to purchase goods or services at step 220.

At step 230, consumer 210 links their banking and financial institution account to their URP account. Linking accounts includes granting the URP account access to the data of the banking and financial institution account. This may be accomplished by entering the respective credentials (e.g. user name and password) in the URP account for the banking and financial institution account, or by entering a unique hyperlink, code, or API key connection.

At step 240, the URP tracks the bank transaction activity of consumer 210. The transaction activity data may be transmitted over one or more networks in an encrypted transmission. The transaction activity data may be stored in one or more URP databases in an encrypted format. The URP may query the banking and financial institution account linked in step 130 for the transaction activity data, or a third party (e.g., Plaid) may query the banking and financial institution account linked at step 230 and the transaction data may be pushed or pulled into to the URP database. Examples of the transactional data obtained from the banking and financial institution account include retailer names, date and time of spend, amount of spend, location of spend, and other parameters.

At step 255, the URP reviews the data from the relevant transactions and provides consumer 210 with a personalized incentive when earned. In this manner, consumer 210 can earn a personalized incentive for spending at any participating operator in a single URP program. Based on analyzing the consumer spending, the URP can predict places where consumer 220 will shop, type of spending habits, travel patterns, estimated income, amount spent by category (e.g., wagering, dining, entertainment, travel, etc.). The URP may also identify problematic spending and high-value consumers based analyzing data from the transactions.

In certain embodiments, if the transaction satisfies a promotion, then the transaction is counted toward the personalized incentive. The personalized incentive may be in form of cash back, discounts, deals, bonuses, gifts, retention incentives, rebates, coupons, promo codes, referral bonuses, and other personalized incentives. The personalized incentive may be delivered via the URP application on the mobile device, via email, via mail, or directly to the banking and financial institution account linked at step 230. The personalized incentive may be locked until a future date or expire within a given time period. The personalized incentive may, for example, be valid for a particular date, time, and/or location. The personalized incentive may or may not be transferrable, or stackable with other promotions.

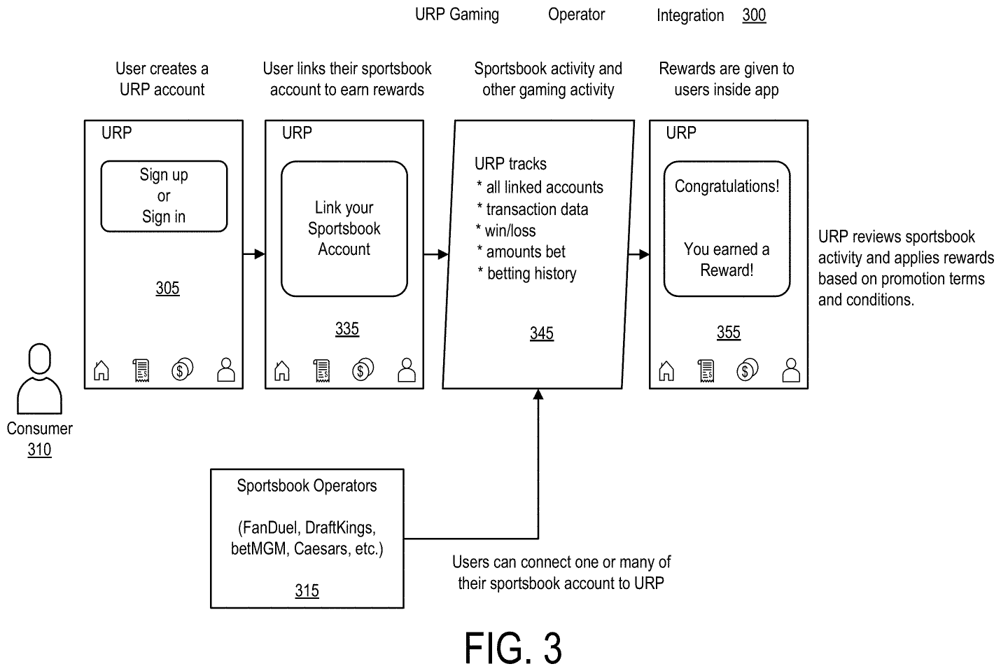

Referring to FIG. 3, URP gaming operator integration 300 may provide a consumer 310 with options to sign-up in step 305, for example, if they are a first time user, or consumer 310 may sign-in at step 305 if a URP account has previously been created. Consumer 210 can use, for example, a mobile device, personal computer, or terminal that runs an application or webpage to enter their personal details in step 205. A first time user would select a user name and password, as well as enter personal information such as their legal name, address, age, and gender, to create a URP account in the URP system.

At step 335, consumer 310 links their wagering account to their URP account. Linking accounts includes granting the URP account access to the data of the wagering account. This may be accomplished by entering the respective credentials (e.g. user name and password) in the URP account for the wagering account, or by entering a unique hyperlink, code, or API key connection. At step 315, consumer 310 places bets with online betting sportsbook operators, or other online wagering operators, such as FanDuel, DraftKings, betMGM, Caesars, etc., or consumer 310 places bets with brick and mortar establishments such as a casino or a horse racing track. Activity for consumer 310 wagering is tracked using their respective wagering accounts (e.g. players club, rewards club, loyalty programs, etc.) with each of the sportsbook operators and other wagering operators.

At step 345, the URP tracks the bank transaction activity of consumer 210. The transaction activity data may be transmitted over one or more networks in an encrypted transmission. The transaction activity data may be stored in one or more URP databases in an encrypted format. The URP may query the wagering account linked in step 335 for the transaction activity data, or a third party may query the wagering account linked in step 335 and the transaction data may be pushed or pulled into to the URP database. Examples of the transactional data obtained from the wagering account include win or loss amounts, date and time of spend, amount of wagers, location of spend, and other parameters.

At step 355, the URP reviews the data from the relevant transactions and provides consumer 310 with a personalized incentive when earned. In this manner, consumer 310 can earn a personalized incentive for spending at any participating wagering operator in a single URP program. Based on analyzing the consumer spending, the URP can predict consumer 320 wagering behavior. The URP can also be able to identify problematic wagering and high-value consumers based analyzing data from the transactions. If the transaction satisfies a promotion, then it is counted toward the personalized incentive. The personalized incentive may be cash back, discounts, deals, bonuses, gifts, retention incentives, rebates, coupons, promo codes, referral bonuses, and other personalized incentives. The personalized incentive may be delivered via the URP application on the mobile device, via email, via mail, or directly to the banking and financial institution account linked in step 335. The personalized incentive may be locked until a future date or expire within a given time period. The personalized incentive may only be valid for a particular date, time, and/or location. The personalized incentive may or may not be transferrable, or stackable with other promotions.

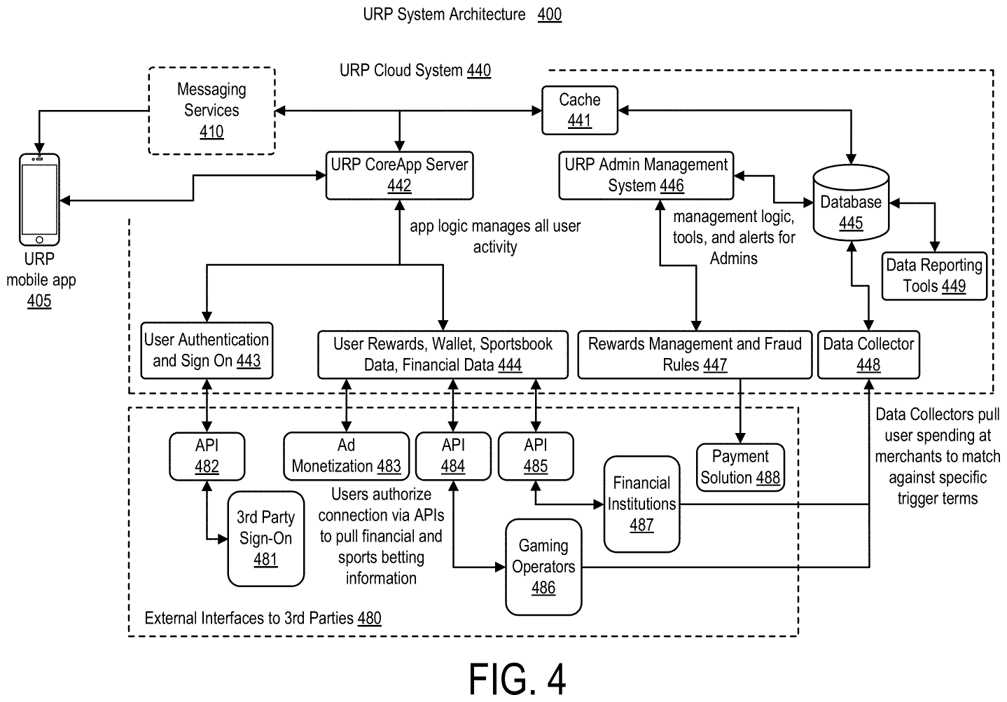

Referring to FIG. 4, an example of a system architecture 400 for a URP is provided. In URP system architecture 400, a consumer downloads and installs a URP application (or app) 405 on a computing device, such as a mobile phone, smart watch, or other computing device. The URP app 405 communicates with a URP cloud system 440 using a data connection to send and receive information. The URP app 405 may directly communicate with the URP core app server 442, and/or communicate through messaging service 410. The URP app 405 communication may be a Short Message Service (SMS), Multimedia Messaging Service (MMS), and/or data over a cellular network. The URP app 405 communication can also be over Wi-Fi, Bluetooth, NFC, and/or an Ethernet connection.

URP cloud system 440 may include at least one of a cache 441, URP core app server 442, user authentication and sign on module 443, user rewards, wallet, sportsbook and financial data module 444, database 445, URP administration management system 446, rewards management and fraud rules module 447, data collector 448, and/or data reporting tools 449. URP cloud system 440 communicates with external interfaces to third parties 480, which may include one or more of third party sign-on system 481, API 482, advertisement monetization system 483, API 484, API 485, gaming operator system 486, financial institution system 487, and/or payment solution system 488.

Cache 441 stores data in a memory and buffers the transmission of data between messaging service 410 and database 445. Cache 441 can also store data in a memory and buffer the transmission of data between URP core app server 442 and database 445. URP core app server 442 manages user activity including the flow of data between the URP app 405 and the URP cloud system 440. User authentication and sign on module 443 is stored within the URP cloud system 440 and provides security against unauthorized use. A third party sign-on system 481 may be used to provide greater security, which communicates with user authentication and sign on module 443 through API 482. Authentication can include confirming a user's identity through, for example, an SMS code that is entered in the URP app 405 upon each login. Authentication can include confirming that a user is an actual person through use of CAPTCHA.

User rewards, wallet, sportsbook and financial data module 444 contains profile data of the URP user. An ad monetization system 483 communicates with user rewards, wallet, sportsbook and financial data module 444 and can provide targeted advertising based on the profile data of the URP user. Gaming operator system 486 also communicates with user rewards, wallet, sportsbook and financial data module 444 through API 484 to provide transaction data about the wagering account of the user. Similarly, financial institution system 487 communicates with user rewards, wallet, sportsbook and financial data module 444 through API 485 to provide transaction data about the banking and financial institution account of the user.

Database 445 stores data received from data collector 448 that is pulled from gaming operator system 486 and financial institution system 487. Data collector 448 can pull consumer spending from various merchants and match the data against specific trigger terms. Database 445 also communicates with data reporting tools 449, which may be used by a URP administrator to generate reports. Database 445 also communicates with URP administration management system 446, which is used to manage and configure the URP system. URP administration management system 446 also communicates with rewards management and fraud rules module 447 to implement measures that prevent misuse of the URP system.

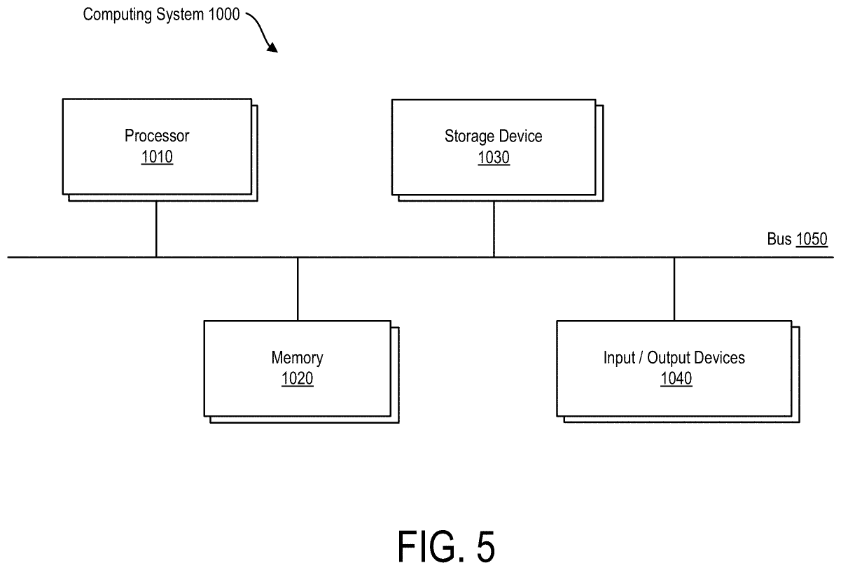

Referring to FIG. 5 a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 5, the computing system 1000 can include a processor 1010, a memory 1020, a storage device 1030, and input/output devices 1040. The processor 1010, the memory 1020, the storage device 1030, and the input/output devices 1040 may be interconnected via a system bus 1050. The processor 1010 is capable of processing instructions for execution within the computing system 1000. Such executed instructions can implement one or more components of, for example, a cloud platform. In some implementations of the current subject matter, the processor 1010 may be a single-threaded processor. Alternately, the processor 1010 may be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 may be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 may be used to execute various interactive computer software applications that may be used for organization, analysis and/or storage of data in various (e.g., tabular) format (e.g., Microsoft Excel®, and/or any other type of software). Alternatively, the computing system 1000 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or may be standalone computing products and/or functionalities. Upon activation within the applications, the functionalities may be used to generate the user interface provided via the input/output device 1040. The user interface may be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

One or more aspects or features of the subject matter described herein may be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal.

The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

### COPYRIGHT & TRADEMARK NOTICES

A portion of the disclosure of this patent document may contain material, which is subject to copyright protection. The applicant has no objection to the reproduction of the patent documents or the patent disclosure as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. A method embedded in a machine-readable medium in form of executable instructions to cause at least one programmable processor to perform operations comprising:
monitoring user activity including events associated with one or more transactions over at least one of a financial platform and a wagering platform;
providing one or more promotions to the user, in response to analyzing user activity and the events,
the one or more promotions including a first amount of reward points added to a loyalty account associated with the user based on a first value associated with a first transaction and a second amount of reward points added to the loyalty account associated with the user based on a second value associated with a second transaction, such that the first amount of reward points is higher than the second amount of reward points, when the first value is greater than the second value; and
accumulating the first reward points and the second reward points in the loyalty account associated with a universal rewards program (URP) that enables the user to use the accumulated reward points across multiple rewards programs associated with the URP.

2. The method of claim 1, wherein the user activity includes at least one or more of a merchandize purchase, a service order, a wagering bet, a credit card transaction, and a bank transaction.

3. The method of claim 1, wherein the first amount of reward points are locked for a first period of time and the second amount of reward points are locked for a second amount of time different than the first amount of time.

4. The method of claim 3, wherein the locking of reward points prevents the user from using the reward points.

5. The method of claim 1, wherein the first reward points are transferable from a first user to a second user.

6. The method of claim 1, wherein the second reward points are non-transferable.

7. The method of claim 1, further comprising identifying problematic wagering based analyzing data associated with the one or more transactions.

8. The method of claim 1, further comprising identifying high-value consumers based analyzing data associated with the one or more transactions.

9. The method of claim 7, wherein the data comprises at least one of win or loss amounts in one or more wagering accounts associated with the user, date and time of a transaction, amount of wagers, location of the transaction.

10. The method of claim 1, further comprising displaying promotional material to the user based on the analyzing of the user activity and the events.

11. A system comprising:
at least one programmable processor; and
a non-transitory machine-readable medium storing instructions that, when executed by the at least one programmable processor, cause the at least one programmable processor to perform operations comprising:
monitoring user activity including events associated with one or more transactions over at least one of a financial platform and a wagering platform;
providing one or more promotions to the user, in response to analyzing user activity and the events,
the one or more promotions including a first amount of reward points added to a loyalty account associated with the user based on a first value associated with a first transaction and a second amount of reward points added to the loyalty account associated with the user based on a second value associated with a second transaction, such that the first amount of reward points is higher than the second amount of reward points, when the first value is greater than the second value; and
accumulating the first reward points and the second reward points in the loyalty account associated with a universal rewards program (URP) that enables the user to use the accumulated reward points across multiple rewards programs associated with the URP.

12. The system of claim 11, wherein the user activity includes at least one or more of a merchandize purchase, a service order, a wagering bet, a credit card transaction, and a bank transaction.

13. The system of claim 11, wherein the first amount of reward points are locked for a first period of time and the second amount of reward points are locked for a second amount of time different than the first amount of time.

14. The system of claim 13, wherein the locking of reward points prevents the user from using the reward points.

15. The system of claim 13, wherein the first reward points are transferable from a first user to a second user.

16. A computer program product comprising a non-transitory machine-readable medium storing instructions that, when executed by at least one programmable processor, cause the at least one programmable processor to perform operations comprising:
monitoring user activity including events associated with one or more transactions over at least one of a financial platform and a wagering platform;
providing one or more promotions to the user, in response to analyzing user activity and the events,
the one or more promotions including a first amount of reward points added to a loyalty account associated with the user based on a first value associated with a first transaction and a second amount of reward points added to the loyalty account associated with the user based on a second value associated with a second transaction, such that the first amount of reward points is higher than the second amount of reward points, when the first value is greater than the second value; and
accumulating the first reward points and the second reward points in the loyalty account associated with a universal rewards program (URP) that enables the user to use the accumulated reward points across multiple rewards programs associated with the URP.

17. The computer program product of claim 16, wherein the user activity includes at least one or more of a merchandize purchase, a service order, a wagering bet, a credit card transaction, and a bank transaction.

18. The computer program product of claim 16, wherein the first amount of reward points are locked for a first period of time and the second amount of reward points are locked for a second amount of time different than the first amount of time.

19. The computer program product of claim 18, wherein the locking of reward points prevents the user from using the reward points.

20. The computer program product of claim 18, wherein the first reward points are transferable from a first user to a second user.
